(19) United States
(12) Patent Application Publication
(10) Pub. No.: US 2005/0200782 A1
(43) Pub. Date: Sep. 15, 2005

(54) MULTI-DOMAIN VERTICAL ALIGNMENT LIQUID CRYSTAL DISPLAY

(76) Inventors: Chien-Hua Chen, Taoyuan (TW); Yu-Fu Lin, Taoyuan (TW); Jung-Lieh Hsu, Taoyuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/905,932

(22) Filed: Jan. 27, 2005

(30) Foreign Application Priority Data
Mar. 11, 2004 (TW) 93106430

(51) Int. Cl. G02F 1/1337

(52) U.S. Cl. 349/129

(57) ABSTRACT

A multi-domain vertical alignment (MVA) liquid crystal display (LCD) comprising a first substrate, a second substrate and a liquid crystal layer disposed between the first substrate and the second substrate is provided. A plurality of first protrusions including a plurality of radiation-shaped protrusions arranged in stripe is formed over the first substrate. In addition, a plurality of second protrusions including stripe protrusions is formed over the second substrate. The first protrusions and the second protrusions are interlaced correspondingly. Since the radiation-shaped protrusions arranged in stripe are disposed over the first substrate, the liquid crystal molecules of the LCD may have more tilt directions. Thus, the range of the viewing angle of the LCD is increased.

### CROSS-REFERENCE TO RELATED APPLICATION

This application claims the priority benefit of Taiwan application serial no. 9 3106430, filed Mar. 11, 2004.

### BACKGROUND OF THE INVENTION

1. Field of the Invention

The present invention relates to a wide viewing angle liquid crystal display (LCD). More particularly, the present invention relates to a multi-domain vertical alignment (MVA) liquid crystal display (LCD).

2. Description of Related Art

In recent years, the liquid crystal display (LCD) is being developed for higher resolution, higher brightness, higher contrast, wider viewing angle, larger display area and higher color resolution. However, the conventional LCD has the disadvantages of narrow range of viewing angle and high price, and the increasing the range of the viewing angle and reducing the cost are important. Presently, a variety of wide viewing angle liquid crystal displays such as multi-domain vertical alignment (MVA) LCD, in-plane switching (IPS) LCD and fringe field switching (FFS) LCD has been developed. In the MVA LCD, the area of the liquid crystal of every pixel is divided into a plurality of sub-areas, therefore the liquid crystal molecule may have a plurality of tilt directions, and thus the range of the viewing angle of the LCD is enhanced.

FIG. 1 is a schematic top view of a pixel of a conventional multi-domain vertical alignment liquid crystal display. Referring to FIG. 1, a scanning line 102, a data line 104, a thin film transistor (TFT) 120 and a pixel electrode 112 are disposed on a substrate (not shown). The thin film transistor (TFT) 120 includes a gate electrode 106, a channel layer 108 and source electrode/drain electrode 110a/110b, wherein the gate electrode 106 is electrically connected to the scanning linescanning line 102, the source electrode 110a is electrically connected to the data line 104, and the drain electrode 1110b is electrically connected to the pixel electrode 112 via the contact window 116.

Generally, in order to increase the viewing angle of the liquid crystal display, a plurality of stripe slits 114 are formed in the pixel electrode 112, and a plurality of stripe protrusions 118 are formed on the opposite substrate (not shown) having a color filter layer. Alternatively, a plurality of stripe protrusions 118 are disposed on the pixel electrode 112, and a plurality of stripe slits 114 are formed on the electrode film (not shown) of the opposite substrate having a color filter layer. Therefore, the liquid crystal molecule disposed between the two substrates may have a variety of tilt directions by the aid of the slit 114 and the protrusion 118. Therefore, the range of the viewing angle of the LCD may be enhanced.

Although the range of the view angle at the horizontal and vertical direction of the MVA LCD described above is enhanced with the aid of the protrusions 118 and the slits 114, however, it should be noted that the tilt direction of the liquid crystal molecule of the MVA LCD is limited in the four specific directions. Therefore, the performance of the range of the view angle of the MVA LCD at another direction, especially at the upper-right, lower-right, upper-left, lower-left direction, is not as good as that at the horizontal and vertical direction. Thus, although the MVA LCD described above is a type of wide viewing angle LCD, however, the development of the MVA LCD is limited due to problems described above. Accordingly, the development of a MVA LCD having more tilt direction of liquid crystal is highly desired.

### SUMMARY OF THE INVENTION

Accordingly, the present invention is directed to a multi-domain vertical alignment (MVA) liquid crystal display (LCD) with a wider range of the viewing angle compared to the conventional MVA LCD. According to an embodiment of the present invention, the MVA LCD with full range of viewing angle is provided.

According to one embodiment of the present invention, a multi-domain vertical alignment (MVA) liquid crystal display (LCD) comprising a first substrate, a second substrate and a liquid crystal layer disposed between the first substrate and the second substrate is provided. In addition, a plurality of first protrusions comprising a plurality of radiation-shaped protrusions arranged in stripe is formed over the first substrate. Moreover, a plurality of second protrusions comprising a plurality of stripe protrusions is formed over the second substrate. The first protrusions and the second protrusions are interlaced correspondingly.

According to another embodiment of the present invention, a multi-domain vertical alignment (MVA) liquid crystal display (LCD) comprising a first substrate, a second substrate and a liquid crystal layer disposed between the first substrate and the second substrate is provided. In addition, a first electrode film including a plurality of first slits is formed over the first substrate, wherein the first slits comprise a plurality of radiation-shaped slits arranged in stripe. Moreover, a second electrode film including a plurality of second slits is formed over the second substrate, wherein the second slit comprises a plurality of stripe slits. The first slit and second slit are interlaced correspondingly.

According to still another embodiment of the present invention, a multi-domain vertical alignment (MVA) liquid crystal display (LCD) comprising a first substrate, a second substrate and a liquid crystal layer disposed between the first substrate and the second substrate is provided. A plurality of protrusions including a plurality of radiation-shaped protrusions arranged in stripe is formed over the first substrate. In addition, an electrode film including a plurality of slits is formed over the second substrate, wherein the slits comprise stripe slits. The protrusions and slits are interlaced correspondingly.

According to yet another embodiment of the present invention, a multi-domain vertical alignment (MVA) liquid crystal display (LCD) comprising a first substrate, a second substrate and a liquid crystal layer disposed between the first substrate and the second substrate is provided. An electrode film including a plurality of slits is formed over the first substrate, wherein the slits comprise a plurality of radiation-shaped slits arranged in stripe. In addition, a plurality of protrusions is formed over the second substrate, wherein the protrusions comprise stripe protrusions. The protrusions and the slits are interlaced correspondingly.

Accordingly, because the radiation-shaped protrusions are arranged in stripe or the radiation-shaped slits, therefore the liquid crystal molecules of the MVA LCD may have more tilt directions, and thus the tilt area may be more symmetric. Thus, the MVA LCD of the present invention may have a full range of viewing angle.

One or part or all of these and other features and advantages of the present invention will become readily apparent to those skilled in this art from the following description wherein there is shown and described one embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view of a pixel structure of a conventional multi-domain vertical alignment (MVA) liquid crystal display (LCD).

FIG. 2 is a schematic top view of a MVA LCD according to one embodiment of the present invention.

FIG. 3A is a schematic cross-sectional view of the MVA LCD along the line I-I′ of FIG. 2.

FIG. 3B is a schematic cross-sectional view of an MVA LCD according to one embodiment of the present invention.

FIG. 4 is a schematic top view of an MVA LCD according to one embodiment of the present invention.

FIG. 5A is a schematic cross-sectional view of an MVA LCD according to one embodiment of the present invention.

FIG. 5B is a schematic cross-sectional view of an MVA LCD according to one embodiment of the present invention.

FIG. 6A is a schematic cross-sectional view of an MVA LCD according to one embodiment of the present invention.

FIG. 6B is a schematic cross-sectional view of an MVA LCD according to one embodiment of the present invention.

FIG. 7A is a schematic cross-sectional view of an MVA LCD according to one embodiment of the present invention.

FIG. 7B is a schematic cross-sectional view of an MVA LCD according to one embodiment of the present invention.

FIG. 8 is schematic view illustrating an enlarged local area 232 of the MVA LCD of FIG. 2.

FIG. 9 is a schematic view of another type of protrusion or slit 231 of an MVA LCD according to one embodiment of the present invention.

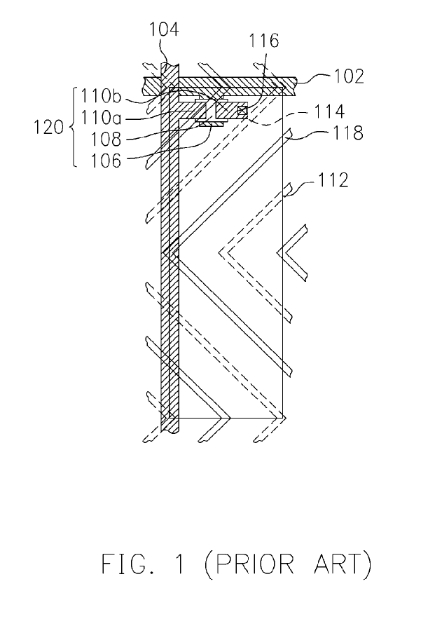

### DESCRIPTION OF EMBODIMENTS

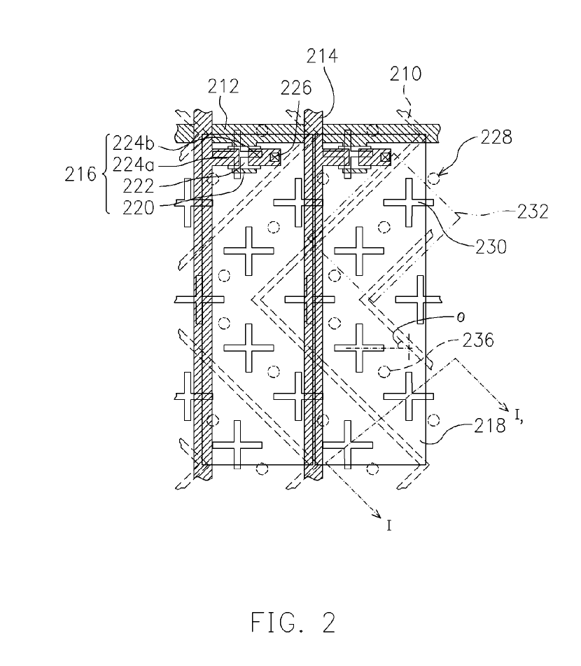

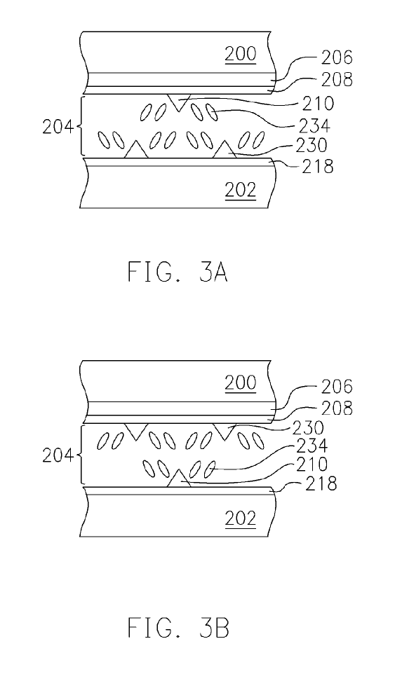

FIG. 2 is a schematic top view illustrating a vertical arranged liquid crystal display (LCD) according to one embodiment of the present invention, wherein the cross-section along line I-I′ of FIG. 2 is illustrated in FIG. 3A.

Referring to FIG. 2 and FIG. 3A, a vertical arrangement (VA) liquid crystal display (LCD) of the present invention includes, for example but not limited to, a first substrate 200, a second substrate 202 and a liquid crystal layer 204 disposed between the first substrate 200 and the second substrate 202. The first substrate 200 includes, for example but not limited to, a color filter film substrate disposed with color filter layer 206. The second substrate 202 includes, for example but not limited to, a thin film transistor (TFT) array substrate disposed with, for example but not limited to, switch components (e.g., thin film transistors) and pixel electrodes. Hereinafter, the LCD of the present invention will be described in detail.

The first substrate 200 includes, for example but not limited to, the color filter layer 206 disposed there-over. The color filter layer 206 includes, for example but not limited to, a plurality of red color filter films (R), a plurality of green color filter films (G) and a plurality of blue color filter films (B). In addition, a black matrix layer is formed between the red color filter films, the green color filter films and the blue color filter films. Moreover, the color filter layer 206 may further include an electrode film 208. The material of the electrode film 208 includes, for example but not limited to, indium tin oxide (ITO). In addition, a plurality of stripe protrusions 210 may be formed over the electrode film 208. The material of the stripe protrusions 210 includes, for example but not limited to, a transparent polymer material.

Moreover, scanning lines 212, data lines 214, switch components (for example but not limited to, thin film transistors) 216 and pixel electrodes 218 may also be formed, for example but not limited to, over the second substrate 202. Each thin film transistors 216 includes a gate electrode 220, a channel layer 222, and a source electrode/drain electrode 224a/224b. The gate electrode 220 is electrically connected to the scanning line 212, and the source electrode 224a is electrically connected to the data line 214. The drain electrode 224b is electrically connected to the pixel electrode 218 via the contact window 226.

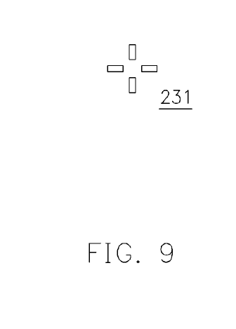

In addition, a plurality of protrusions 228 is disposed over the pixel electrode 218, and the protrusion 228 includes a plurality of radiation-shaped protrusions 230 arranged in stripe. The stripe protrusions 210 and the radiation-shaped protrusions 230 arranged in stripe are interlaced correspondingly. The material of the radiation-shaped protrusions 230 includes, for example but not limited to, a transparent polymer material. In one embodiment of the present invention, the radiation-shaped protrusions 230 includes, for example but not limited to, X-shaped protrusions as shown in FIG. 2. In addition, an angle between the extension direction of the radiation of the radiation-shaped protrusions 230 and the extension direction of the stripe protrusions 210 is, for example but not limited to, about 45° (e.g., angle θ as shown in FIG. 2). In addition, in one embodiment of the present invention, the radiation-shaped protrusions 230 may also be X-shaped protrusions 231 in which the center is not crossed (as the protrusion 231 shown in FIG. 9). However, the radiation-shaped protrusions 230 or 231 of the present invention is not limited to a protrusion having four mutually perpendicular directions, but may also be designed as a multi-directional radiation-shaped protrusion according to the requirement.

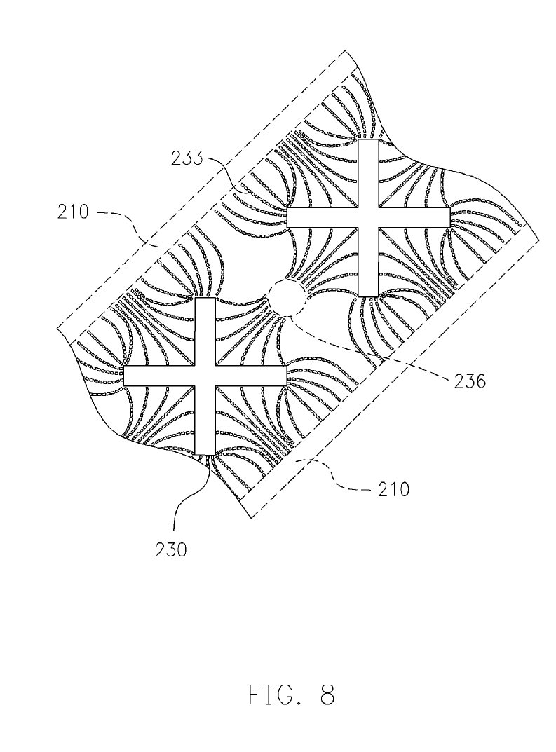

It is noted that, the radiation-shaped protrusions 230 arranged in stripe is provided for replacing the conventional stripe protrusions. Therefore, when the MVA LCD of the present invention is operated, the liquid crystal molecules 234 of the liquid crystal layer 204 are tilted along the distribution direction of the virtual line 233 as the enlarged local area 232 of FIG. 2 (as shown in FIG. 8) due to the electric field generated between the electrode film 208 and the pixel electrode 218. In other words, the liquid crystal molecules 234 of the liquid crystal layer 204 are arranged from the center of the radiation-shaped protrusions 230 towards every directions, therefore the distribution of the tilt direction of the tilt liquid crystal molecules 234 are increased. Thus, the tilt area of the liquid crystal molecules 234 is almost symmetric, and the distribution of the angle of the liquid crystal molecules 234 is almost full-directional arranged. Thus, the range of the viewing angle of the MVA LCD of the present invention may be enhanced.

In addition, in one embodiment of the present invention, the round-shaped protrusion 236 may be further disposed over the electrode film 208 of the opposite substrate in the gap between two adjacent radiation-shaped protrusions 230. Therefore, the phenomenon of generating disclination area may be avoided at the interface between two adjacent radiation-shaped protrusions 230 when the liquid crystal molecules 234 are under the action of the electric field. In other words, the lateral extension of the field line of the electric field is limited by disposing the round-shaped protrusions 236. Therefore, the problem of discontinuous arrangement of the liquid crystal molecules 234 at the interface between two adjacent radiation-shaped protrusions 230 is avoided, and thus the possibility of generating disclination area can be reduced.

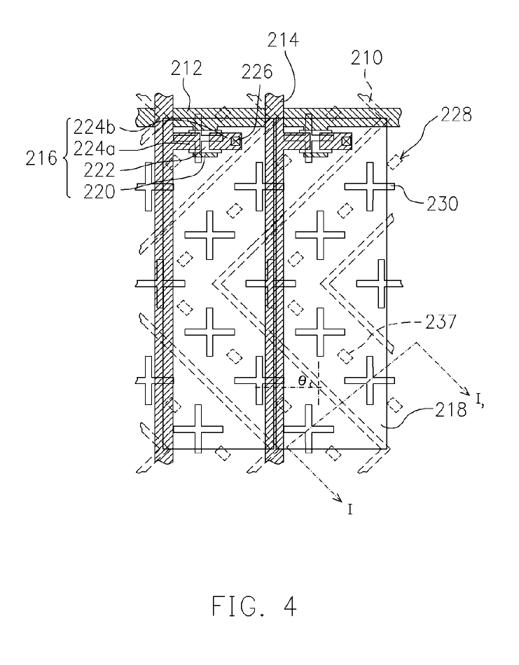

Moreover, in one embodiment of the present invention, the linear protrusions 237 as shown in FIG. 4 may also be disposed over the electrode film 208 of the opposite substrate in the gap between two adjacent radiation-shaped protrusions 230. It is noted that, the linear protrusions 237 may function same as the round-shaped protrusions 236 described above. Furthermore, the round-shaped protrusions 236 or the linear protrusions 237 described above may also be replaced by slits. In other words, the electrode film 208 may be designed with corresponding round or linear slits and can be disposed on the opposite substrate in the gap between two adjacent radiation-shaped protrusions 230. Therefore, the phenomenon of generating disclination area in the liquid crystal molecules 234 at the interface may also be avoided.

Moreover, in the embodiment described above, the radiation-shaped protrusions 230 arranged in stripe may also be disposed over the electrode film 208 of the first substrate 200 as illustrated in FIG. 3B instead of being disposed over the pixel electrode 218 of the second substrate 202. Referring to FIG. 3B, in the vertical arrangement (VA) liquid crystal display (LCD), the radiation-shaped protrusions 230 arranged in stripe is disposed over the electrode film 208 of the first substrate 200, and the stripe protrusions 210 are disposed over the pixel electrode 218 of the second substrate 202. Therefore, the liquid crystal molecules 234 of the liquid crystal layer 204 may have more tilt directions with respect to the radiation-shaped protrusions 230 arranged in stripe over the electrode film 208 and the stripe protrusions 210 arranged over the pixel electrode 218. Thus, the range of the viewing angle is increased.

Furthermore, according to an embodiment of the present invention, the slits may also be utilized instead of using protrusions 210, 228 and 230 in a manner that the liquid crystal molecules 234 have more tilt directions with respect to the slits. Therefore, the range of the viewing angle is increased. Hereinafter, the related embodiments will be described.

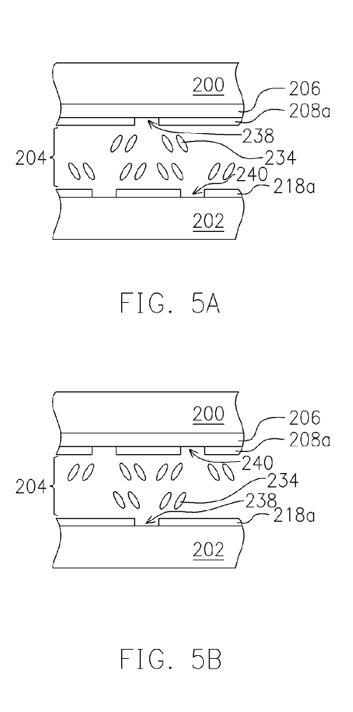

Referring to the embodiment of the present invention shown in FIG. 5A, the electrode film 208a including a plurality of stripe slits 238 is formed over the color filter layer 206 formed over the first substrate 200. The position of the stripe slits 238 is same as that of the stripe protrusions 210 (as shown in FIG. 3A) described above. Moreover, the pixel electrode 218a including a plurality of radiation-shaped slits 240 arranged in stripe is disposed over the second substrate 202. The position of the radiation-shaped slits 240 is same as that of the radiation-shaped protrusions 230 arranged in stripe (as shown in FIG. 3A) described above. In one embodiment of the present invention, the radiation-shaped slits 240 may be, for example but not limited to, X-shaped slits. Alternatively, the radiation-shaped slits 240 may also be X-shaped slits 231 in which the center is not crossed (as shown in FIG. 9). However, the radiation-shaped protrusions 240 of the present invention is not limited to a protrusion having four mutually perpendicular directions, but may also be designed as a multi-directional radiation-shaped protrusion according to the requirement. In addition, the other components shown in FIG. 5A are similar or same as those shown in FIG. 3A and therefore detailed description thereof will not be repeated. In the present embodiment, the liquid crystal molecules 234 in the liquid crystal layer 204 may have more tilt directions with respect to the corresponding stripe slits 238 in the electrode film 208a and the radiation-shaped slits 240 arranged in stripe in the pixel electrode 218a. Thus, the range of the viewing angle is increased.

Moreover, in another embodiment of the present invention, round-shaped slit or linear slit may also be disposed in the electrode film 208a of the opposite substrate in the gap between two adjacent radiation-shaped slits 240. The position of the round-shaped slit or linear slit may be same as that of the round-shaped protrusion 236 (as shown in FIG. 2) or the linear protrusion 237 (as shown in FIG. 4). Therefore, the phenomenon of generation of disclination area of the liquid crystal molecules 234 at the interface between two adjacent radiation-shaped slits 240 may be reduced. Similarly, in another embodiment of the present invention, the slits described above may be replaced by the round or linear protrusions disposed over the electrode film 208a of the opposite substrate between two adjacent radiation-shaped slits 240.

In addition, in the embodiment described above, the radiation-shaped slits 240 arranged in stripe may also be disposed over the electrode film 208a formed over the first substrate 200 as illustrated in FIG. 5B instead of being disposed in the pixel electrode 218a over the second substrate 202, wherein the stripe slits 238 are disposed in the pixel electrode 218a over the second substrate 202.

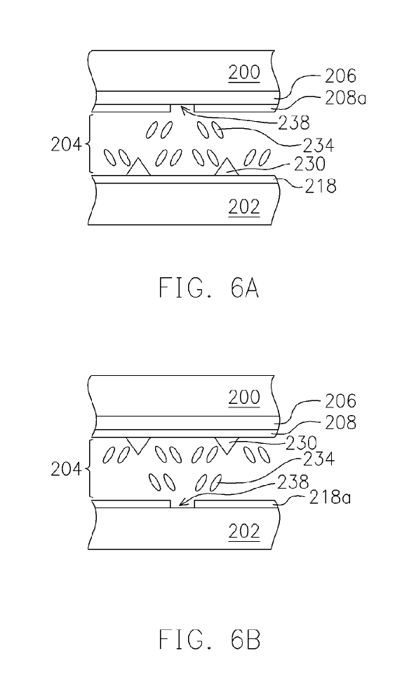

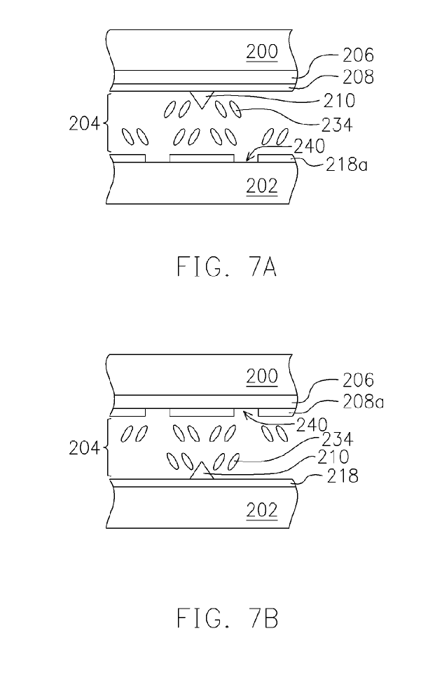

Furthermore, the silts along with the protrusions as shown in FIG. 6A, FIG. 6B, FIG. 7A and FIG. 7B may be utilized in a manner that the liquid crystal molecules 234 will have more tilt directions with respect to the silts the protrusions. Therefore, the range of the viewing angle is increased. Hereinafter, the related embodiments will be described.

Referring to FIG. 6A, an electrode film 208a including a plurality of stripe slits 238 is formed over the color filter layer 206 formed over the first substrate 200 of the vertical arrangement (VA) LCD. The position of the stripe slits 238 is similar to or same as that of the stripe protrusions 210 (as shown in FIG. 3A). Moreover, the radiation-shaped protrusions 230 arranged in stripe (as shown in FIG. 3) may also be disposed over the pixel electrode 218 formed over the second substrate 202. In addition, other components shown in FIG. 6A are similar to or same as those shown in FIG. 3A and therefore detailed description thereof will not be repeated. Similarly, the liquid crystal molecules 234 in the liquid crystal layer 204 may have more tilt directions with respect to the corresponding stripe slits 238 in the electrode film 208a and the radiation-shaped slits 230 arranged in stripe. Thus, the range of the viewing angle is increased.

Furthermore, in one embodiment of the present invention in, the round-shaped protrusion, linear protrusion, round-shaped slit or linear slit may also be disposed over the electrode film 208a of the opposite substrate in the gap between two adjacent radiation-shaped protrusions 230. It is noted that, the position of the linear protrusion, round-shaped slit or linear slit may be similar or same as that of the round-shaped protrusions 236 (as shown in FIG. 2) or the linear protrusions 237 (as shown in FIG. 4). Therefore, the phenomenon of generation of disclination area of the liquid crystal molecules 234 at the interface between two adjacent radiation-shaped protrusions 230 may also be avoided.

In addition, in the embodiment described above, the radiation-shaped protrusions 230 arranged in stripe may also be disposed over the electrode film 208 formed over the first substrate 200 as illustrated in the embodiment of the present invention shown in FIG. 6B except for being disposed over the pixel electrode 218 over the second substrate 202, wherein the stripe slits 238 are disposed over the pixel electrode 218a over the second substrate 202.

Referring to FIG. 7A, a plurality of stripe protrusions 210 as shown in FIG. 3A are disposed over the electrode film 208 formed over the first substrate 200 of the vertical arrangement (VA) LCD. In addition, the pixel electrode 218a including a plurality of radiation-shaped slits 240 arranged in stripe is disposed over the second substrate 202. Moreover, the position of the radiation-shaped slits 240 is similar or same as that of the radiation-shaped protrusions 230 arranged in stripe (as shown in FIG. 3A) described above. In addition, the other components shown in FIG. 7A are similar or same as those shown in FIG. 3A, and therefore detailed description thereof will not be repeated. Similarly, the liquid crystal molecules 234 in the liquid crystal layer 204 may have more tilt directions with respect to the corresponding stripe protrusions 210 over the electrode film 208a and the radiation-shaped slits 240 arranged in stripe in the pixel electrode 218a. Thus, the range of the viewing angle is increased.

Furthermore, in one embodiment of the present invention in, the round-shaped protrusion, linear protrusion, round-shaped slit or linear slit may also be disposed over the electrode film 208 of the opposite substrate in the gap between two adjacent radiation-shaped protrusions 240. It is noted that, the position of the linear protrusion, round-shaped slit or linear slit may be similar or same as that of the round-shaped protrusions 236 (as shown in FIG. 2) or the linear protrusions 237 (as shown in FIG. 4). Therefore, the phenomenon of generation of disclination area of the liquid crystal molecules 234 at the interface between two adjacent radiation-shaped slits 240 may also be avoided.

In addition, in the embodiment described above, the radiation-shaped slits 240 may also be disposed over the electrode film 208a formed over the first substrate 200 in a manner described in the embodiment with reference to FIG. 7B instead of being disposed on the pixel electrode 218a over the second substrate 202, wherein stripe protrusion 210 is disposed over the pixel electrode 218 over the second substrate 202.

Accordingly, because the radiation-shaped protrusions are being arranged in stripe or the radiation-shaped slits, therefore the liquid crystal molecules of the MVA LCD may have more tilt directions, and thus the tilt area may be more symmetric. Thus, the MVA LCD of the present invention may have full range of viewing angle.

The foregoing description of the embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A multi-domain vertical alignment (MVA) liquid crystal display (LCD), comprising:
a first substrate, comprising a plurality of first protrusions formed thereon, wherein the first protrusions comprises a plurality of radiation-shaped protrusions arranged in stripe;
a second substrate, comprising a plurality of second protrusions formed thereon, wherein the second protrusions comprise stripe protrusions, and the first protrusions and the second protrusions are interlaced correspondingly; and
a liquid crystal layer, disposed between the first substrate and the second substrate.

2. The MVA LCD of claim 1, further comprising:
a round-shaped slit or protrusion, disposed over the second substrate having the stripe protrusions, and disposed corresponding to a gap between adjacent two of the radiation-shaped protrusions.

3. The MVA LCD of claim 1, further comprising:
a linear slit or protrusion, disposed over the second substrate having the stripe protrusions, and disposed corresponding to a gap between adjacent two of the radiation-shaped protrusions.

4. The MVA LCD of claim 1, wherein the radiation-shaped protrusions comprise a plurality of X-shaped protrusions.

5. The MVA LCD of claim 1, wherein when the first substrate comprises a color filter film, the second substrate comprises a thin film transistor (TFT) array substrate, and vice versa.

6. A multi-domain vertical alignment (MVA) liquid crystal display (LCD), comprising:
a first substrate, comprising a first electrode film, wherein the first electrode film comprises a plurality of first slits and the first slits comprise a plurality of radiation-shaped slits arranged in stripe;
a second substrate, comprising a second electrode film, wherein the second electrode film comprises a plurality of second slits comprising a plurality of stripe slits, and wherein the first slit and the second slit are interlaced correspondingly; and
a liquid crystal layer, disposed between the first substrate and the second substrate.

7. The MVA LCD of claim 6, further comprising:
a round-shaped slit or protrusion, disposed over the second substrate having the stripe slits, and disposed corresponding to a gap between adjacent two of the radiation-shaped slits.

8. The MVA LCD of claim 6, further comprising:
a linear slit or protrusion, disposed over the second substrate having the stripe slits, and disposed corresponding to a gap between adjacent two of the radiation-shaped slits.

9. The MVA LCD of claim 6, wherein the radiation-shaped slits comprise a plurality of X-shaped slits.

10. The MVA LCD of claim 6, wherein when the first substrate comprises a color filter film substrate, the second substrate comprises a thin film transistor (TFT) array substrate, and vice versa.

11. A multi-domain vertical alignment (MVA) liquid crystal display (LCD), comprising:
a first substrate, comprising a plurality of protrusions, wherein the protrusion comprising a plurality of radiation-shaped protrusions arranged in stripe;
a second substrate, comprising an electrode film, wherein the electrode film comprises a plurality of slits, and the slits comprises a plurality of stripe slits, and wherein the protrusions and the slits are interlaced correspondingly; and
a liquid crystal layer, disposed between the first substrate and the second substrate.

12. The MVA LCD of claim 11, further comprising:
a round-shaped slit or protrusion disposed over the second substrate having the stripe slits, and disposed corresponding to a gap between adjacent two of the radiation-shaped protrusions.

13. The MVA LCD of claim 11, further comprising:
a linear slit or protrusion disposed over the second substrate having the stripe slits, and disposed corresponding to a gap between adjacent two of the radiation-shaped protrusions.

14. The MVA LCD of claim 11, wherein the radiation-shaped protrusions comprises a plurality of X-shaped protrusions.

15. The MVA LCD of claim 11, wherein when the first substrate comprises a color filter film substrate, the second substrate comprises a thin film transistor (TFT) array substrate, and vice versa.

16. A multi-domain vertical alignment (MVA) liquid crystal display (LCD), comprising:
a first substrate, comprising an electrode film, and the electrode film comprises a plurality of slits, wherein the slit comprises a plurality of radiation-shaped slits arranged in stripe;
a second substrate, comprising a plurality of protrusions, and the protrusion comprises a plurality of stripe protrusions, and the protrusions and the slits are interlaced correspondingly; and
a liquid crystal layer, disposed between the first substrate and the second substrate.

17. The MVA LCD of claim 16, further comprising:
a round-shaped slit or protrusion, disposed over the second substrate having the stripe protrusions, and disposed corresponding to a gap between adjacent two of the radiation-shaped slits.

18. The MVA LCD of claim 16, comprising:
a linear slit or protrusion, disposed over the second substrate having the stripe protrusions, and disposed corresponding to a gap between adjacent two of the radiation-shaped slits.

19. The MVA LCD of claim 16, wherein the radiation-shaped slits comprise a plurality of X-shaped slits.

20. The MVA LCD of claim 16, wherein when the first substrate comprises a color filter film substrate, the second substrate comprises a thin film transistor (TFT) array substrate, and vice versa.
